(19) United States
(12) Patent Application Publication
(10) Pub. No.: US 2008/0256115 A1
(43) Pub. Date: Oct. 16, 2008

(54) Systems, apparatuses and methods for identifying transitions of content

(76) Inventors: Oleg Beletski, Espoo (FI); Marcel Keppels, Masala (FI); Jukka T. Heinonen, Helsinki (FI)

Correspondence Address: Hollingsworth & Funk, LLC, Suite 125, 8009 34th Avenue South, Minneapolis, MN, 55425, US

(21) Appl. No.: 11/786,327

(22) Filed: Apr. 11, 2007

(51) Int. Cl. G06F 17/30

(52) U.S. Cl. 707/102; 707/E17.143

(57) ABSTRACT

Systems, apparatuses and methods for identifying the end of the presentation of a content item such as a song, and/or identifying transitions from one content item to another. Content is presented via a device. A calculated fingerprint(s) representative of at least a portion of the content is transmitted. A more comprehensive content fingerprint for the content is received in response to the transmission of the calculated fingerprint. The device locally compares further calculated fingerprints to the received content fingerprint to identify an end to the presentation of the content.

### FIELD OF THE INVENTION

This invention relates in general to delivered content identification, and more particularly to systems, apparatuses and methods for identifying transitions from one delivered or otherwise presented media item to another.

### BACKGROUND OF THE INVENTION

When originally introduced into the marketplace, analog mobile telephones used exclusively for voice communications were viewed by many as a luxury. Today, mobile communication devices are highly important, multi-faceted communication tools. A substantial segment of society now carries their mobile devices with them wherever they go. These mobile devices include, for example, mobile phones, Personal Digital Assistants (PDAs), laptop/notebook computers, and the like. The popularity of these devices and the ability to communicate “wirelessly” has spawned a multitude of new wireless systems, devices, protocols, etc. Consumer demand for advanced wireless functions and capabilities has also fueled a wide range of technological advances in the utility and capabilities of wireless devices. Wireless devices not only facilitate voice communication, but also messaging, multimedia communications, e-mail, Internet browsing, and access to a wide range of wireless applications and services.

More recently, wireless communication devices are increasingly equipped with other media capabilities such as radio receivers. Thus, a mobile phone can be equipped to receive amplitude modulated (AM) radio and/or frequency modulated (FM) radio signals, which can be presented to the device user via a speaker or headset. With the processing power typically available on such a mobile communication device, broadcast radio can be a more rich experience than with traditional radios. For example, a terminal (e.g., mobile phone, PDA, computer, laptop/notebook, etc.) is often equipped with a display to present images, video, etc. Terminals are also often capable of transmitting and/or receiving data, such as via GSM/GPRS systems or otherwise. These technologies enable such terminals to present images, video, text, graphics and/or other visual effects in addition to presenting the audio signal received via the radio broadcast. For example, the song title, artist name, album name, and/or other information or “metadata” relating to a song broadcast from a radio station can be provided to a terminal for visual presentation in addition to the audio presentation.

Such a “visual radio service” or other media provider may provide such information during a time when the song or other media item is being presented via the user terminal(s). More particularly, in the context of radio services, visual radio services can be provided by certain radio stations that are integrated with visual radio content creation tools. If a song is being sent to a terminal's radio application, the radio station server(s) can provide information such as the artist name, album name, image graphics and the like to the terminal.

However, the visual information may not correspond to the audio signal at all times, which can adversely affect the user's experience. For example, network congestion may cause the metadata or other information to be delayed in reaching the terminal. Thus, the terminal may already be playing a new audio item (e.g., song on the radio) although the presented information (e.g., artist name, album name, etc.) reflects a prior audio item. Current techniques for synchronizing the audio and information channels may provide for poor end of song detection and/or result in an inordinate quantity of data traveling through the mobile network.

Accordingly there is a need in the industry for, among other things, reducing the load on the network(s), improving end of song detection capabilities, and synchronizing multiple media portions such as audio signals and visual data. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses systems, apparatuses and methods for identifying transitions of delivered content.

In accordance with one embodiment, a method is provided that involves presenting content via a device, and transmitting a calculated fingerprint(s) representative of at least a portion of the content. A content fingerprint for the content is received in response to the transmission of the calculated fingerprint. The device locally compares further calculated fingerprints to the received content fingerprint to identify an end to the presentation of the content.

According to more particular embodiments, the method may further involve receiving metadata associated with presented content. This metadata may be received in response to transmitting the calculated fingerprint(s). In a more particular embodiment, the method may further involve presenting at least some of the metadata contemporaneously with the presentation of the content via the device. One embodiment further involves discontinuing presentation of the metadata upon detection of the end to the presentation of the content. In another embodiment, the content may include at least an audio stream of audio items, and the method may involve presenting at least a portion of the metadata via a device display during the audio presentation of the corresponding audio item. In a more particular embodiment, at least one of the audio items may include a song, and presenting at least a portion of the metadata may thus involve visually presenting text, graphic or other visual information related to the song currently being played via the audio stream.

According to still other particular embodiments, such a method may further involve the device locally calculating the fingerprint(s) representative of at least a portion of the content, and locally calculating the further/additional fingerprints that are compared to the content fingerprint. According to another embodiment, the content may include multiple content items, where receiving a content fingerprint thus involves receiving a fingerprint representative of at least a remaining part of the content item from which the calculated fingerprint was based. In another embodiment, receiving a content fingerprint may involve receiving a fingerprint representing multiple portions of the content item from which the calculated fingerprint was based. In still another embodiment, receiving a content fingerprint may involve receiving a fingerprint representative of any temporal portion of the content item from which the calculated fingerprint was based. Yet another embodiment involves receiving a content fingerprint by receiving a more comprehensive fingerprint relative to the calculated fingerprint in response to transmitting the calculated fingerprint.

In another particular embodiment of such a method, the content may include streaming content. In such a case, the method may further involve the device calculating the fingerprint(s) by generating the fingerprint(s) for a temporal portion of the streaming content. In one embodiment, the calculated fingerprints are compared to the content fingerprint until the calculated fingerprint no longer corresponds to the content fingerprint. In another embodiment, the method further involves repeatedly calculating the fingerprints at the device and locally comparing the calculated fingerprints to the content fingerprint until the calculated fingerprint no longer corresponds to the content fingerprint. In yet another embodiment, the method further involves calculating the fingerprints at the device and locally comparing the calculated fingerprints to the content fingerprint substantially continuously, and doing so until the calculated fingerprint no longer corresponds to the content fingerprint.

In accordance with another embodiment of the invention, a method is provided that includes receiving a partial fingerprint representative of a portion of a content item. The method further includes locating a content fingerprint based on the content item identified by the partial fingerprint, and transmitting the content fingerprint associated with the content item corresponding to the partial fingerprint for use by devices in locally detecting an end of a local presentation of the content item.

According to one embodiment, such a method may further involve locating metadata based on the content item identified by the partial fingerprint, and transmitting the metadata associated with the content item for use by the devices in presenting the metadata in connection with presenting the content item. In another embodiment, the metadata includes information characteristics related to the located content item, and includes any one or more of textual, audio, graphical or multimedia information.

In another embodiment, locating a content fingerprint involves searching a song database to locate a song represented by the partial fingerprint. In still another embodiment, the method further involves searching a database to locate the content item represented by the partial fingerprint, and locating a content fingerprint by identifying the content fingerprint associated with the content item located in the database. In a more particular embodiment, the method further includes locating metadata from the database based on the content item identified by the partial fingerprint, and transmitting the metadata associated with the content item for use by devices in presenting at least some of the metadata in connection with presentation of the content item.

In one embodiment of such a method, the content fingerprint is a more comprehensive fingerprint for the content item relative to the partial fingerprint. In another embodiment, when a device has locally identified an end of a local presentation of a content item, the process of receiving a partial fingerprint, locating a content fingerprint, and transmitting the content fingerprint is repeated for each subsequent content item.

In accordance with another embodiment, a method is provided that involves calculating a partial fingerprint at a device for a portion of an audio segment playing on the device. The device then determines when the audio segment has stopped playing on the device by locally performing repeated partial fingerprint calculations and comparisons of the resulting partial fingerprints to one or more reference fingerprints for that audio segment.

In accordance with another embodiment of such a method, the reference fingerprint(s) includes one or more prior partial fingerprints calculated at the device for that audio segment, and where locally performing comparisons of the resulting partial fingerprints to a reference fingerprint for that audio segment involves locally performing comparisons of the resulting partial fingerprints to the prior partial fingerprint calculation(s) on the device for that audio segment.

According to another embodiment, such a method further involves performing a search at a network element for the audio segment based on the calculated partial fingerprint, and providing an audio segment fingerprint as the reference fingerprint to the device in response to locating the audio segment. In a more particular embodiment, performing repeated partial fingerprint calculations and comparisons involves performing repeated partial fingerprint calculations and comparisons of the resulting partial fingerprints to the audio segment fingerprint received from the network element.

In accordance with another embodiment of the invention, an apparatus is provided that includes a user interface configured to present content. The apparatus includes a transmitter configured to transmit at least one calculated fingerprint representative of at least a portion of the presented content. A receiver is configured to receive a content fingerprint for the presented content in response to transmitting the calculated fingerprint(s), and a comparator or other compare module is provided to compare further calculated fingerprints to the content fingerprint to identify an end of the content presentation.

In one embodiment, the user interface includes a visual and/or audio component. For example, the user interface may include a display, and/or a speaker(s), headphone jack(s), etc.

In other embodiments of such an apparatus, a fingerprint calculation module may be configured to calculate the calculated fingerprint(s) based on at least a portion of the presented content, and to calculate the further calculated fingerprints used for comparison to the content fingerprint. In another embodiment, the user interface is further configured to present metadata associated with the content and received in response to transmitting the at least one calculated fingerprint. In another particular embodiment, the user interface is further configured to discontinue presentation of the metadata upon detection of the end of the content presentation. In one embodiment, the user interface includes at least a display.

In another embodiment of such an apparatus, a memory is provided, which is configured to locally store the content fingerprint for the presented content. In such an embodiment the compare module may be further configured to compare further calculated fingerprints, of a subsequent presentation of the content, to the locally stored content fingerprint to identify the end of the subsequent presentation of the content.

In accordance with another embodiment of the invention, an apparatus is provided that includes a receiver configured to receive a calculated fingerprint representative of a portion of a content item. A content analysis module is configured to locate a content fingerprint based on the content item identified by the calculated fingerprint. A transmitter is configured to send the content fingerprint associated with the located content item for use by devices in locally identifying an end of a local presentation of the content item.

In other embodiments of such an apparatus, the content analysis module is further configured to locate metadata associated with the content item, based on the content item identified by the calculated fingerprint. In still another particular embodiment, the content analysis module includes instructions and a processing system capable of executing the instructions to search a database for the content item and the metadata identified by the calculated fingerprint.

The above summary of the invention is not intended to describe every embodiment or implementation of the present invention. Rather, attention is directed to the following figures and description which sets forth representative embodiments of the invention.

### BRIEF DESCRIPTION OF THE DRAWINGS

The invention is described in connection with the embodiments illustrated in the following diagrams.

FIG. 1 is a block diagram generally illustrating one embodiment of an efficient manner for detecting terminations or transitions of content items in accordance with the invention;

FIG. 2A is a flow diagram illustrating one embodiment of a method for locally detecting the end/change of play of a content item in accordance with the present invention;

FIG. 2B is a flow diagram illustrating an exemplary embodiment of a method for locally detecting the end/change of a song played via a radio on a device in accordance with the present invention;

FIG. 3 is a flow diagram illustrating an exemplary embodiment of a more particular embodiment of a manner of detecting the end/change of a song played via a radio on a device in accordance with the present invention;

FIG. 4 is a message flow diagram illustrating exemplary information exchanges to effect the initiation and termination of the presentation of metadata in accordance with one embodiment of the invention;

FIG. 5 illustrates an exemplary use case as chronologically viewed from the perspective of the device;

FIGS. 6A and 6B illustrate flow diagrams of representative methods for detecting the end of a song or other content item that is presented via a device;

FIGS. 7A and 7B illustrate flow diagrams of representative methods for providing content fingerprints and ultimately facilitating end-of-content detection;

FIG. 8 is a flow diagram illustrating another representative embodiment of a method for providing song fingerprints and enabling devices to detect the end of an audio segment; and

FIG. 9 illustrates representative device and server system(s) in which the present invention may be implemented or otherwise utilized.

### DETAILED DESCRIPTION OF EMBODIMENTS OF THE INVENTION

In the following description of exemplary embodiments, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

Generally, the present invention provides systems, apparatuses and methods for detecting the end of a presentation of a content/media item. In one embodiment, a device consumes (e.g., presents; plays) content, such as playing a song. The content item is identified externally to the device through the use of a fingerprint generated and provided by the device for that content item. A more comprehensive fingerprint is returned to the device, which in turn accepts responsibility for detecting the end of the song or other content item using further locally calculated fingerprints and the more comprehensive fingerprint received by the device. In this manner, the device itself performs the task of detecting when the song or other content item has ended. As is described more fully below, detection of the end of the content item may be desirable for various reasons such as, for example, knowing when to start and stop presenting metadata that corresponds to the content item being presented at the device.

The description provided herein often refers to radio content (e.g., broadcast radio such as AM/FM radio) as a media type, but it should be recognized that the present invention is equally applicable to any type of transmitted content/media. These other types of content media include, but are clearly not limited to, radio, television, webcasts, podcasts, and/or other transmitted media. In one embodiment, the invention provides approaches to content generation and detection for visual radio services (e.g., NOKIA Visual Radio Service™) for any radio station that is received by a mobile terminal. These radio stations may be any type, such as frequency modulated (FM), amplitude modulated (AM), etc. As used herein, visual radio (or analogously, visual media) involves any visually presented information associated with the audio transmission, such as the song title, artist, album name, album cover art, advertiser/product, video clips, music videos, and/or other information that may correlate to the provided audio transmission.

One embodiment of the invention proposes manners for enabling content generation for services such as visual radio services, while enhancing the timing or synchronization of different yet cooperative media items such as audio and associated visual data. Particularly, media delivered to a terminal may be “recognized” at the terminal or elsewhere, such that associated data may be provided to augment the media with the data. Where the media is an audio stream such as in the case of broadcast radio, the receiving terminal may recognize a currently played song, and may also receive data (e.g., artist name, album name, album image, etc.) to augment the audio experience with that data. For example, as a mobile device user listens to a song-A via the mobile device, data indicating the song-A name, artist, album, album cover image, and/or other related data may be presented to the user via the mobile device. The same may be applied in the case of television signals, animations, podcasts, albums, and/or other media that can be delivered to and/or played at a terminal.

In one embodiment, identification of the data associated with a currently played media item involves using media recognition technology. For example, in the case of radio transmissions, song recognition technology may be used where the mobile terminal calculates an audio fingerprint and provides it to a server(s) for recognition and content creation. Generally, “fingerprinting” is a technique used for song identification. Fingerprints are typically (but not necessarily) smaller in size than the actual digital content, yet contain enough information to uniquely identify the song or other media item. Each audio fingerprint is sufficiently unique to identify a song or other media item. Any known “fingerprinting” technology that allows continuous/repeated recognition, or recognition from any part of the song or other content, may be used in connection with the invention. After receiving the fingerprint and identifying the music piece or other media, the visual radio server can send content that matches the currently broadcast song or other media item to the terminal.

In order to generate the visual content with the radio or other media broadcast, an exemplary fingerprinting task may be performed relatively continuously, or at least repetitively. By continuously and/or repeatedly recognizing the received content, a song (or other media item) change can be determined. By recognizing the song change, visual content for the terminated song can be discontinued, and new visual content can be created for the next song. It is important to have both the audio and visual channels at least somewhat “synchronized” in that the correct visual data is presented while the corresponding audio content is being played. Otherwise, it would be confusing and frustrating for the user to be presented with visual content whose presentation timing does not substantially align with the start and end of its corresponding song or other media item. Identifying the end of or change of song (or other media item) “continuously” does not necessarily mean without any gaps—rather, “continuously” as used herein generally suggests that the task is repeated often enough to avoid significant confusion to the user.

More particularly, assume a mobile device has radio capabilities such as a frequency modulated (FM) and/or amplitude modulated (AM) radio. Assume that such mobile device includes a client side application(s) to digitize some or all of the received audio and calculate a fingerprint(s) from this digitized information. As previously indicated, such a fingerprint typically involves less data than that of the original digitized audio, but enough to uniquely identify the song or other media item. The mobile device may send the fingerprint over the mobile and/or other network(s) to a visual radio server, which uses the fingerprint to locate the appropriate information for that song/media from a database. This information may include, for example, a song name, artist name, album name and/or cover image, advertisements, and/or any other information that may be relevant to the currently played song or otherwise desirable to associate with the currently played song. It takes time for the fingerprint to be calculated and sent over the network, and for the associated media information to be located from the database and returned to the mobile terminal. Among other things, the time required includes the time, and network delays, involved in communicating the fingerprint and the resulting metadata, as well as the processing time to perform all of the transmission, locating, and/or other functions involved in the transaction. This latency can cause the audio signal and visual data received at the mobile device to be offset in time, or otherwise “unsynchronized” such that the received data does not correspond to the simultaneously received audio.

In one example, detection of when a current song ends may be accomplished by repeating the fingerprint calculation and song recognition procedure continuously. More particularly, the mobile terminal can calculate and transmit a fingerprint and receive the corresponding metadata via the network over and over until the calculated fingerprint results in the receipt of metadata for a new song. This continuous, repetitive activity places significant stress on the network and involved components. In such an approach, the end of song detection occurs with some delay since it takes time for the fingerprint to reach the server, for the server to search through the database, and for the response to arrive. During that delay, content that does not correspond to the currently consumed media stream may be presented to the terminal user. As a more particular example, the song played via a mobile device's radio module can change during the latency resulting from these processing and network delays, thereby presenting incorrect visual data for the new song being heard via the radio broadcast. Among other things, the present invention improves the timing in detecting the end of songs or other media items, and reduces the quantity of data traversing the network.

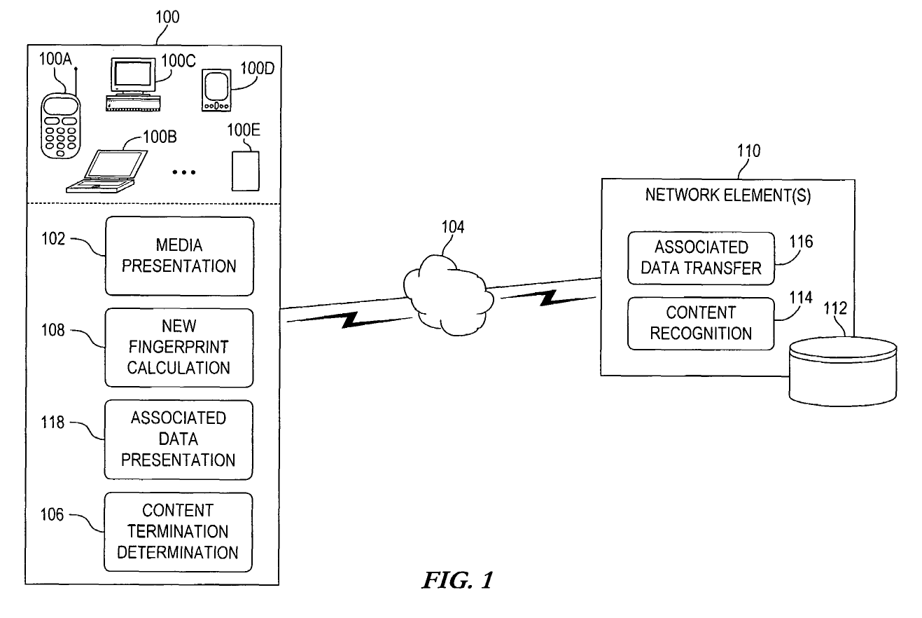

FIG. 1 is a block diagram generally illustrating one embodiment of an efficient manner for detecting terminations or transitions of content items in accordance with the invention. As is described in the embodiment of FIG. 1, as least some of the song or other media item recognition is delegated to the device that is consuming or otherwise utilizing the media. For example, in one embodiment, media item recognition involving the detection of the end of the song or other media item is performed at the consuming device. As will be described in greater detail below, this “local” detection involves more focused actions, which do not adversely affect processing at the device while addressing the aforementioned and other shortcomings of the prior art.

Referring now to FIG. 1, a device 100 is illustrated. The device can be any type of device capable of presenting media 102, such as, for example, a mobile phone 100A, portable computing device 100B, desktop computing device 100C, personal digital assistant 100D or other device 100E capable of presenting media and communicating information via a network(s) 104. Another example is a radio in a home, automobile or otherwise that includes processing capabilities to calculate fingerprints and perform functions as set forth herein. The media presentation 102 can involve any type of media and corresponding presentation. For example, the media may be television, radio, webcast, podcast and/or other type of media that can be presented. Such a “presentation” can involve any type of information perceivable by the user of the device 100, such as, for example, visual information, audio information, tactile information, etc. As a more particular example, the device 100 may include an FM and/or AM radio, where the “presentation” would then include at least an audio presentation of the radio signal.

As will be described more fully below, one aspect of the present invention involves the content termination determination 106 performed at the local device 100. The device 100 obtains enough information regarding the media stream to perform comparisons between this information and the currently played media. In this manner, the device 100 itself can determine when the information and currently played media no longer match, thereby indicating the termination of the currently played media. For example, the device 100 may become privy to data indicative of a song, and the device 100 repeatedly calculates a fingerprint(s) for the currently played song to compare to that data. If there is a match, it indicates that the same song is still being played. If the currently played song and the data do not match, it is indicative of the termination of the prior song and/or playing of a new song/content.

In one exemplary embodiment, the device 100 partakes in a new fingerprint calculation 108, which involves calculating a fingerprint(s) for a song or other content item that has not yet been recognized or identified. This information can be sent via a network(s) 104 to a network element(s) 110, which includes or otherwise has access to a database 112 or other storage of data that may be used to accompany corresponding media/content. In one embodiment, a database 112 of content is stored, where the calculated fingerprints are used to ultimately locate the data that corresponds to that fingerprint(s). This database 112 can be stored in a stand-alone terminal, server, etc. This database 112 can alternatively be stored in a distributed server system, and/or in other distributed systems including any one or more of the terminal, server, etc. In one embodiment, the content is stored in a database 112 associated with a server 110, where the calculated fingerprint is used to index the database 112 to obtain the associated data. This data may be any data associated with the media stream. For example, where a radio broadcast represents the media stream, this “data” or “content” may be visual radio content such as a song title, author/artist, album cover art, artist photos or images, related trivia, artist biographies, and/or any other information that may pertain to the current media stream item. In other embodiments, the content may not specifically relate to the current media stream item (e.g., song), but may represent other content such as advertisements, coupons or discounts, trivia, concert information, “next song” indications, etc.

The network element 110 engages in content recognition 114, such as by using the received fingerprint information to identify the correct song or other content, and thereby recognizing the data associated therewith. This associated data can be transferred 116 to the device 100, where is can be presented 118. For example, the data may include album graphics and/or text to visually present the artist, song title, etc.

In one embodiment, the network element 110 also provides actual fingerprint data for the currently played song/content. This actual fingerprint data may be located based on the database search, which in turn was based on the calculated fingerprint(s) received from the device 100 on which the content is being played. In this manner, the device 100 can then compare this actual fingerprint data to repeatedly calculated fingerprint data to determine 106 when that currently played song or other content has stopped playing. This actual fingerprint data may be referred to herein as the media fingerprint, or reference fingerprint. For example, when a partial fingerprint is calculated at a device 100, the calculation may (and typically is) directed to a portion or subset of an entire fingerprint that would represent that song/content. In order to identify the song/content, the network element(s) 110 and/or database 112 stores fingerprint data for a larger portion of the song/content, and typically for the entire song/content. Thus, the media fingerprint or reference fingerprint relates to the actual fingerprint for that song or other content to which a comparison of the device-calculated fingerprint can be made. In another embodiment, the device 100 can compare the repeatedly calculated fingerprint data with the previously calculated fingerprint data that was sent to the network element to ultimately identify the desired associated data (often referred to herein as “metadata”). In such an embodiment, the “reference” fingerprint is provided locally, and is based on prior fingerprint data calculated at the device 100. Regardless of the origin of the reference fingerprint(s), when the content termination determination 106 indicates that the song/media item has stopped or changed to another media item, then a new fingerprint calculation 108 can be executed to obtain new associated data for presentation 118.

Detection of the end of a song or other media item is beneficial where associated data is to be presented substantially contemporaneously with the play of the song or other media item. For example, in the case of a song being played on the device, it may be desirable to display information such as the song title, artist, album graphics, song time remaining, and/or other information. When that song ends, the presented song title, artist, and the like will no longer be valid. Therefore, detection of the end of the song/item is important so that the proper associated data (e.g., song title, artist, etc.) corresponds to the song/item that is being played.

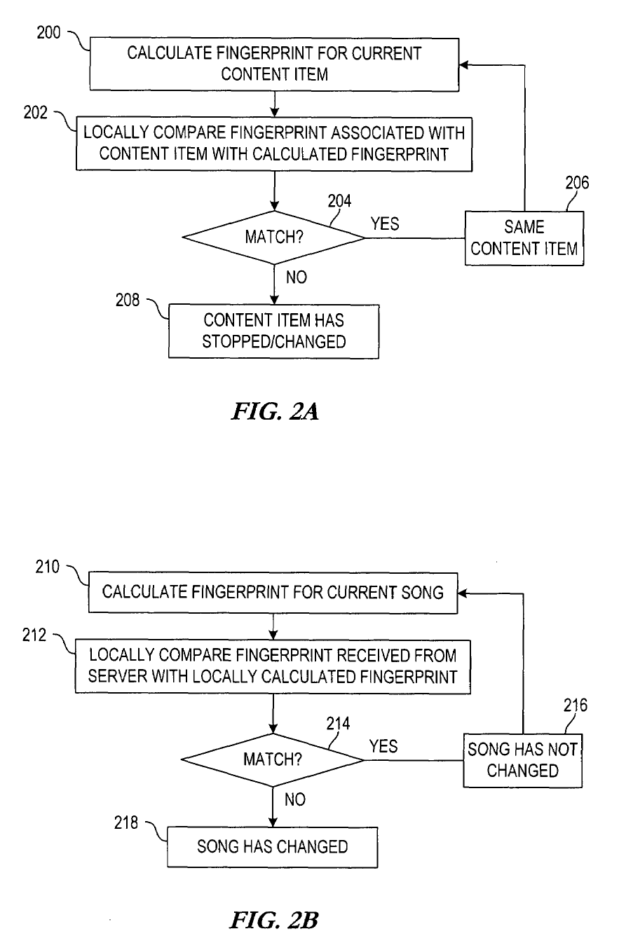

FIG. 2A is a flow diagram illustrating one embodiment of a method for locally detecting the end/change of play of a content item in accordance with the present invention. A fingerprint for the current content item is calculated 200. The calculated fingerprint is locally compared 202 with a fingerprint associated with that content item. The fingerprint associated with that content item may be received from another source, such as a server. In another embodiment, and depending on the type of content item, the fingerprint associated with that content item (e.g., reference fingerprint) may be the fingerprint first locally calculated at the device. For example, if the content item has repetitive characteristics, or is otherwise identifiable from any portion of the content item, then the fingerprint previously calculated for that content item at the device may be used as the reference fingerprint for purposes of comparing to the newly calculated fingerprints. Otherwise, the previously calculated fingerprint can be used to index or otherwise locate (e.g., in a database) a reference fingerprint that can be used to identify remaining portions of the content item.

In another embodiment, fingerprint data may be cached or otherwise stored at the device for future comparisons. For example, when a song plays for the first time, the media or reference fingerprint can be provided by a server or other network element, and stored on the device for later use in comparing to newly calculated fingerprints at the device. As another example, fingerprint data previously calculated at the device may be locally cached or otherwise stored at the device. Radio stations often play the most popular songs repetitively, and thus the device can recognize such songs and locally store the media/reference fingerprint data for those songs. After such fingerprint data has been locally stored, the device can first check if the song/content can be identified using the locally stored fingerprint data for previously played songs. If no match is locally found, then the identification request can be sent to the server or other network element.

If the reference fingerprint matches 204 a newly calculated fingerprint, this indicates that the currently played content item is still the same content item 206 that was playing when the reference fingerprint was determined. In other words, the content item has not terminated or changed to another content item. In such case, further fingerprints can be calculated 200 for more comparisons 202 to the reference fingerprint to ultimately determine when the content item has stopped or changed to another content item. If there is no match 204, this is indicative of a changed/stopped content item 208. More particularly, if the reference fingerprint does not match the newly, locally calculated fingerprint, the content item has stopped playing and/or the media has changed to a different content item.

FIG. 2B is a flow diagram illustrating an exemplary embodiment of a method for locally detecting the end/change of a song played via a radio on a device in accordance with the present invention. A fingerprint is calculated 210 for the current song. A reference fingerprint is obtained from a server(s), and is locally compared 212 with the newly calculated fingerprint. If there is a match 214, the same song is still playing; i.e., the song has not changed 216, and further fingerprint calculations 210 can be made for comparison 212. If there is no match 214, the song has evidently changed or otherwise stopped playing. In other words, if the fingerprints do not match, the assumption is that the currently calculated fingerprint must correspond to a new song, commentary, advertisement, or other content, thereby indicating termination of the song that was being monitored.

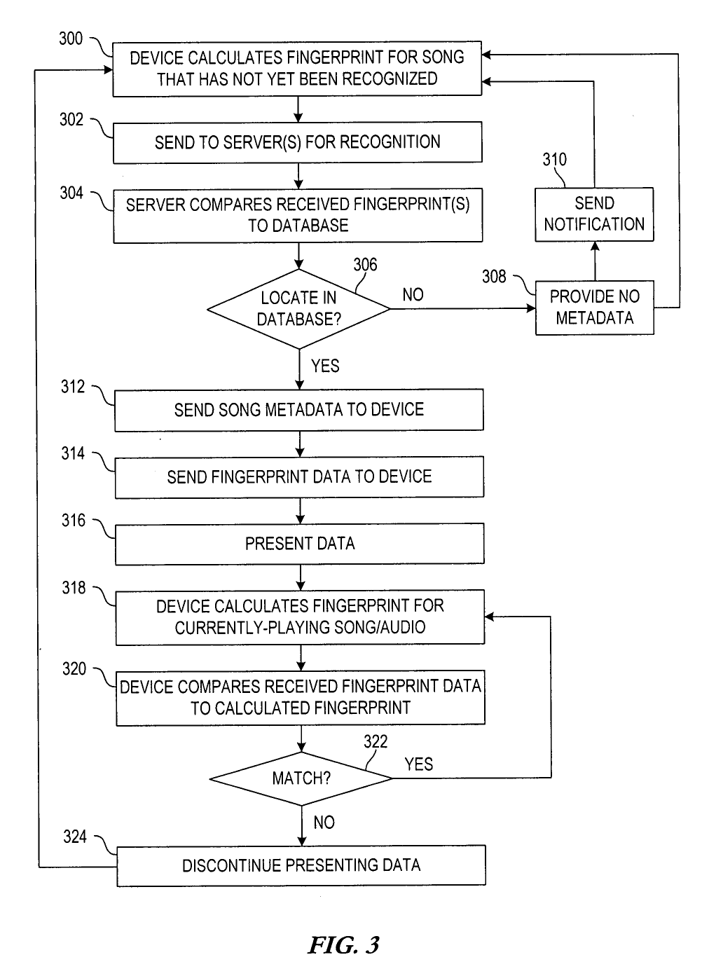

FIG. 3 is a flow diagram illustrating an exemplary embodiment of another method for locally detecting the end/change of a song played via a radio on a device in accordance with the present invention. The exemplary embodiment of FIG. 3 is equally applicable to content/media items other than an audio song provided via a radio broadcast. The device calculates 300 a fingerprint for a song that has not yet been recognized. In the illustrated embodiment, the calculated fingerprint is sent 302 to a server(s) for song recognition. The server compares 304 the received fingerprint to a database to ultimately locate the song metadata corresponding to the received fingerprint. If the song is not associated with the database, no metadata is provided 308, and in one embodiment a notification may be sent 310 to the device to indicate that the song metadata could not be located.

If it is determined 306 that the song metadata is located in the database, the server sends 312 the song metadata to the device, and in one embodiment also sends fingerprint data corresponding to the song to the device. While the device initially calculates some fingerprint data that can be used by the server to locate the particular song, the song is likely different at a point midway through the song than it was at the time the initial fingerprint was calculated. Therefore, fingerprint data for the entire song may be stored with the song's metadata, which can then be sent 314 to the device. As will be described more fully below, this fingerprint thus serves as a reference for comparison to the song as it plays on the device.

When the device receives the metadata, it can present 316 it via the device. For example if the metadata is audio data, it can be presented via a speaker(s) or headset associated with the device. This may be appropriate where the content/media being consumed is a visual image. For example, if the content is a still image of a piece of museum art, the metadata can provide an audio presentation indicating the name of the piece of art, the artist, the museum where the original is on display, etc. In the illustrated embodiment where the media is an audio radio signal, the metadata may be presented visually, such as via a display on the device. More particularly, as a song plays on the device, the metadata may be presented on the device display. This metadata may include, for example, text of the artist and album names, an image of the album cover art, etc.

In the embodiment of FIG. 3, the device also has received the reference fingerprint data as shown at block 314. Using this reference fingerprint data, the device calculates 318 more fingerprints for the currently-playing song. The newly calculated fingerprint is compared 320 to the received, reference fingerprint data. If there is a match 322, this indicates that the same song is still playing, and the device continues to calculate 318 more fingerprints. This occurs until the received fingerprint data does not match 322 the calculated fingerprint, thereby indicating that the current song has stopped (e.g., a new song is being played on the radio). When this occurs, the presentation of the metadata is discontinued 324, so that it does not appear to the device user to be associated with the new audio/song being played on the radio. Further, the device can now calculate 300 a new fingerprint for this new song/audio that has not yet been recognized, and the process continues to enable the appropriate metadata to be presented with the appropriate song/audio.

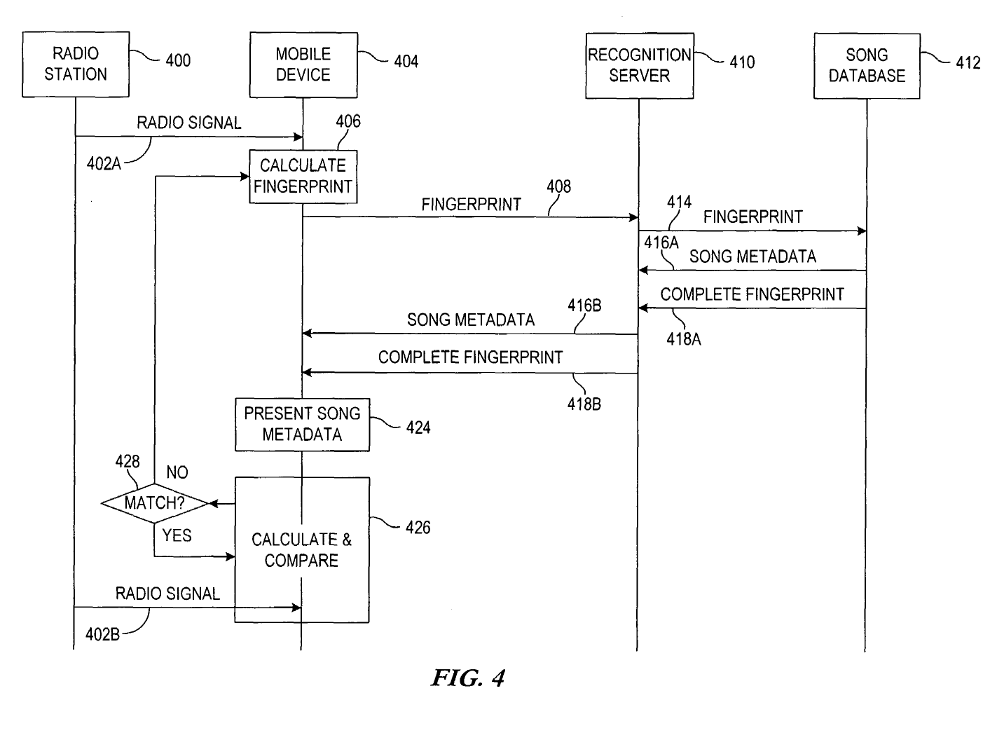

As previously indicated, one embodiment of the invention involves the use of a network entity(s), such as a recognition server, to locate the song being played based on a calculated fingerprint from the consuming device. FIG. 4 is a message flow diagram illustrating an embodiment involving a radio station providing an audio signal, and a recognition server to search for the current song based on a calculated fingerprint. It should be recognized that the description of FIG. 4 is equally applicable to other forms of content or media, such as television, network-delivered content (e.g., webcasts, podcasts, Internet video, images or audio, etc.). It is also equally applicable to other sources of media, such as an audio CD, DVD, removable memory, media stick, and/or other media that can be played via devices.

In the illustrated embodiment, a radio station 400 provides a radio signal 402A. While the radio signal could be provided to the mobile device 404 via the Internet, local area network and/or other network(s), it is assumed for purposes of FIG. 4 that the radio signal 402A is an over-the-air (OTA) broadcast radio signal. Thus, it is also assumed that a device, a mobile device 404 in the present example, is equipped with a radio client such as an FM and/or AM radio. The radio signal 402A includes a modulated audio signal, such as a disc jockey voice, song, advertisement, commentary, and/or any other audio that may be associated with a radio station 400 signal 402A. For purposes of this example, it is assumed that the radio signal 402A is currently delivering a song that will be referred to as SONG-A. The mobile device 404 calculates 406 a fingerprint for the new (i.e., not yet recognized) SONG-A, and sends 408 the calculated fingerprint to a recognition server 410. The server 410 includes or otherwise has access to a memory, storage, database or other component(s) where song information is stored. In the illustrated embodiment, the song information is stored in a database 412, referred to herein as a song database. This database 412 stores at least the song metadata for at least some of the songs that may be played by the radio station 400, and locates the appropriate song metadata based on the calculated fingerprint sent 408 by the mobile device 404. The database 412 may also store a more complete fingerprint for the particular song. Thus, if the mobile device 404 provides 408 a calculated fingerprint to the recognition server 410, the server 410 in turn provides 414 the fingerprint to the database 412 for use in locating the SONG-A. The database 412 returns 416A, 418A the song metadata and complete fingerprint for SONG-A to the recognition server 410, which in turn provides 416B, 418B the metadata and complete fingerprint to the mobile device 404.

When the mobile device 404 receives the metadata, it can present 424 that song metadata. For example, it may display the artist name, song title, album art and/or other information on a display screen. The mobile device 404 continues to calculate 426 fingerprints for the currently playing audio, and compares the resulting fingerprints to the more complete fingerprint received 418B from the recognition server 410. As long as the calculated fingerprints match 428 the complete (i.e., reference) fingerprint, SONG-A is still playing and the song metadata for SONG-A should continue to be presented 424. However, when SONG-A ends and some other audio starts as depicted by the radio signal 402B, SONG-A has ended, and the mobile device 404 should detect that. The device 404 detects the end of SONG-A by calculating a fingerprint for the new radio signal 402B, and since SONG-A ended the calculated fingerprint will not longer match 428 the reference fingerprint. In this case, presentation 424 of the song metadata can be discontinued until the next song, referred to as SONG-B, can be detected and the appropriate metadata obtained. When the calculated fingerprint does not match 428 the reference fingerprint, the mobile device 404 will not have enough information to detect which song has now started to play on the radio, and will have to again calculate 406 a new fingerprint to send 408 to the server 410. The process then continues, and when the metadata for SONG-B is obtained from the database 412, this new metadata for SONG-B can be presented 424 via the mobile device 404.

FIG. 5 illustrates an exemplary use case as chronologically viewed from the perspective of the device. In the example of FIG. 5, the media/content is assumed to be an audio radio signal, however from the description provided herein those skilled in the art can readily appreciate that the description of FIG. 5 is equally applicable to other forms of media. At time A, a first song (SONG-A) begins. At time B, the display 500A of the device does not yet present any metadata for SONG-A. At time C, the device sends a fingerprint calculated at the device for SONG-A. In response, at time D, the device receives the appropriate metadata and a reference fingerprint for SONG-A. Using this metadata, at time E the device presents the metadata 502 via the display 500B. The metadata may include, for example, the artist name, song title, song time remaining, album graphics, and/or other information.

The device then repeatedly calculates a fingerprint sufficient to compare to the reference fingerprint as shown at times F, G, H and J. While the calculated fingerprint matches the reference fingerprint, the metadata continues to be presented. At time I a new song, SONG-B, begins playing. The fingerprint calculated at the device no longer matches the reference fingerprint, and can remove the metadata as depicted by display 500C. Further, the device sends a new calculated fingerprint at time K to obtain the metadata for SONG-B. When this metadata is obtained at time M, it can be presented as shown by the metadata 504 on the display 500D.

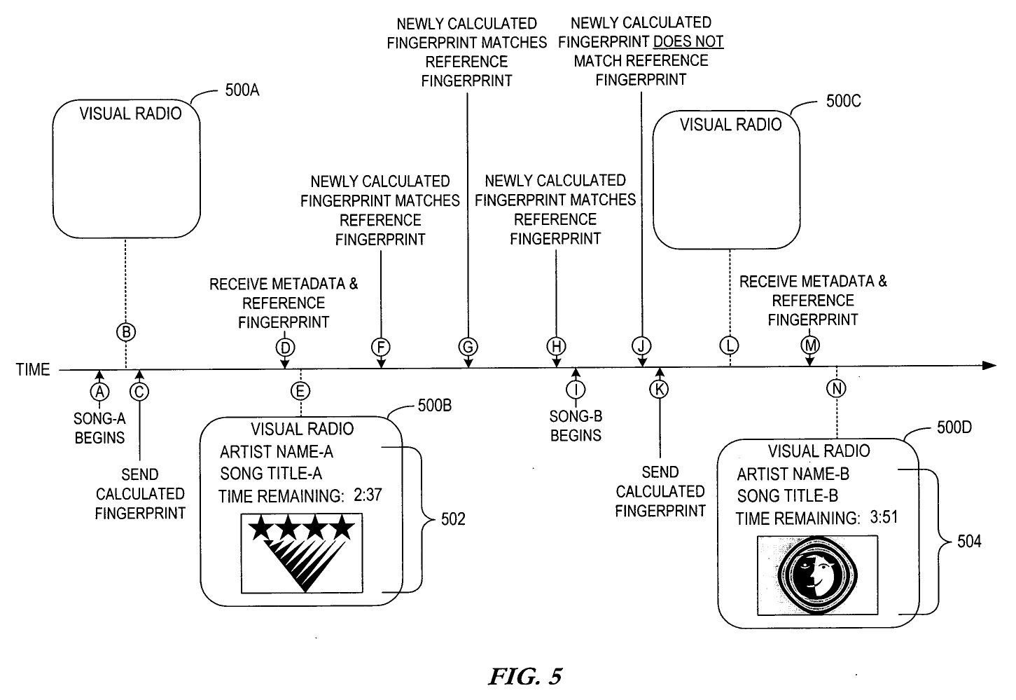

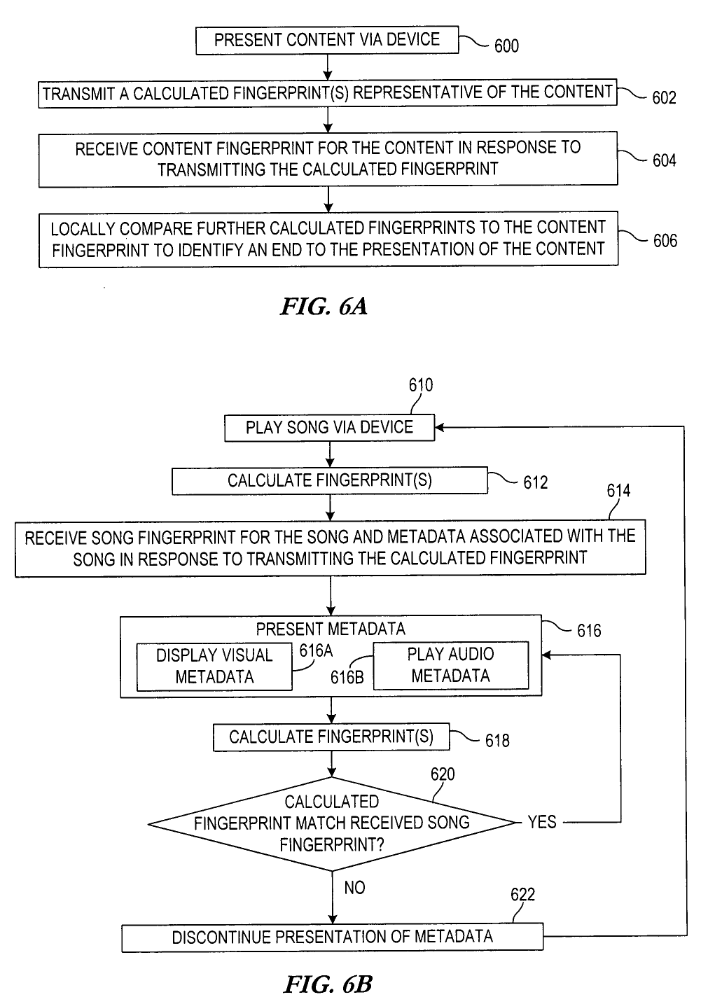

FIG. 6A is a flow diagram illustrating one embodiment of a method for detecting the end of a song or other content item that is presented via a device. The device may be any type of device, such as a mobile/wireless device (e.g., mobile phone, PDA, laptop/notebook computer, radio, etc.), computing device, audio/stereo component, and the like. In the illustrated embodiment, some content is presented 600 via the device. This “presentation” is any manner of providing the content that is ultimately perceivable by the device user. For example if the content is an audio stream, then “presenting” 600 the content may include providing an audio output of that audio stream; e.g., audibly playing a song or other audio item. If the content is video, then “presenting” 600 may involve providing an audio and/or visual presentation.

A calculated fingerprint(s) that is representative of the content is transmitted 602. In one embodiment, the calculated fingerprint(s) is obtained by the device itself calculating the fingerprint(s) based on the presented 600 content. Other embodiments may involve the use of remote devices or systems to assist in the calculation of the fingerprint which may then be made accessible to the device.

In response to transmitting the calculated fingerprint(s), at least one fingerprint for the content item is received 604. In one embodiment, this “reference fingerprint” or “content fingerprint” represents a larger segment of the content item, which may include up to the entire content item. For example, a fingerprint calculated at the device may be a partial fingerprint corresponding to a portion or subset of the entire content being presented (e.g., a ten second portion of a song), yet is still representative of that content. On the other hand, a content fingerprint received 604 by the device may correspond to a larger portion or all of the entire content being presented. In the embodiment of FIG. 6A, the device locally compares 606 further calculated fingerprints to the content fingerprint to identify/detect an end to the device's presentation of the content. For example, by comparing 606 this information, the device can detect when an audio song has stopped streaming to the device.

FIG. 6B is a flow diagram illustrating another, more specific embodiment of a method for detecting the end of a song or other content item that is presented via a device. In the illustrated embodiment, the content is assumed to be a song or other audio item, although the flow diagram of FIG. 6B is equally applicable to other content. In one embodiment, the content includes streaming content such as a radio broadcast, webcast or other delivery mechanism. The song is played 610 via the device. In the illustrated embodiment, the device calculates 612 a fingerprint(s) for the song. For example, where the content is streaming content such as a streaming song, the device may calculate the fingerprint(s) by generating the fingerprint(s) for a temporal portion of the streaming content; e.g., a fingerprint representative of five seconds of the song.

In the illustrated embodiment, the device receives 614 a song fingerprint for the song, and metadata associated with the song, in response to transmitting the calculated fingerprint. The received song fingerprint may be a more comprehensive fingerprint relative to the calculated fingerprint. In another example, the song fingerprint may relate to only a remaining portion of that song or other content item. For example, if the device-calculated fingerprint corresponded to a ten second period from the thirty second (00:30) point in a four minute song to the forty second (00:40) point in the song, then the song fingerprint received in response may include a fingerprint from no earlier than 00:40 until approximately the end (i.e., 04:00) of the song. In another embodiment, the song fingerprint is representative of substantially all of the song or other content item.

The embodiment of FIG. 6B further involves presenting 616 metadata that relates to the song (or other content item) that is being presented via the device. For example, where the content is a song, the song title and artist may be visually displayed 616A. The metadata can alternatively/additionally be presented via audibly, such as via a speaker or headphone jack. For example, where the content being presented is visual, it may be beneficial to present the metadata in an audio manner 616B. In one embodiment, the metadata is presented contemporaneously with the presentation of the song, so that the device user can see/hear the metadata when the song is being played.

In accordance with the present invention, the end of the song can be detected. One reason to detect the end of the song is to discontinue presenting the metadata when the song has ended. In the illustrated embodiment, the device calculates further fingerprints 618, which are compared to the received song fingerprint. If the calculated fingerprint matches 620 the received song fingerprint, the same song is still being played via the device, and the metadata continues to be presented 616. Otherwise, when there is no match 620, this indicates that the song has ended, and presentation of the metadata for that song is discontinued 622. Thus, in one embodiment, this local comparison occurs until the calculated fingerprint no longer corresponds to the song fingerprint. These fingerprint calculations 618 can occur at any desired frequency or quantity. For example, the calculations 618 may occur periodically, sporadically, substantially continuously, or any other desired frequency. It is noted that as a statistical average, the more often the calculation 618 and comparison 620 is performed, the less time the metadata will be incorrectly presented for a previous song.

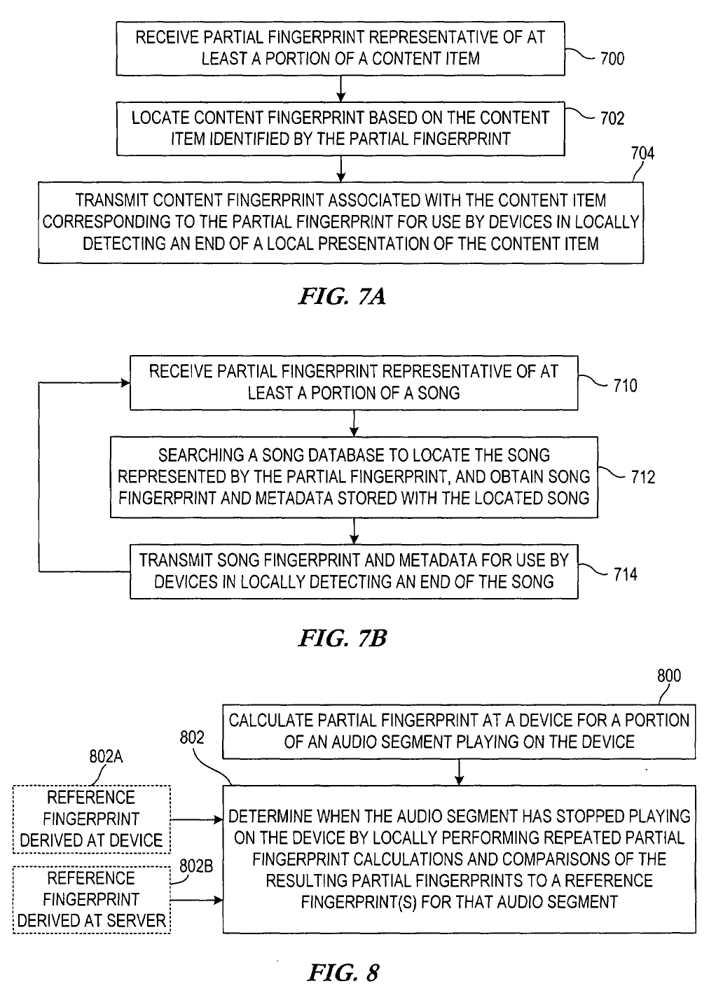

FIG. 7A is a flow diagram illustrating one embodiment of a method for providing content fingerprints and ultimately facilitating end-of-content detection. A partial fingerprint(s) representative of at least a portion of a content item is received 700. A content fingerprint based on the content item identified by the partial fingerprint is located 702. The located content fingerprint that is associated with the content item is transmitted 704 for use by devices in locally detecting an end of a local presentation of the content item.

FIG. 7B is a flow diagram illustrating a representative embodiment of a method for providing song fingerprints and enabling devices to detect the end of a song. While FIG. 7B is described in terms of the content being a song, those skilled in the art from the description herein will recognize that FIG. 7B is equally applicable to other forms of content.

In the illustrated embodiment, a server receives 710 a partial fingerprint(s) representative of at least a portion of a song. The server searches 712 a song database to locate the song represented by the partial fingerprint, and obtains a song fingerprint and metadata stored with the located song. As previously indicated, the metadata may be any information and of any form desired, such as, for example, textual, audio, graphical, multimedia and/or other information providing characteristics of the song. Furthermore, the song fingerprint may be a fingerprint that is more comprehensive than the partial fingerprint used to initially identify the song. The song fingerprint and metadata are transmitted 714 for use by devices in locally detecting an end of the song. This process 710, 712, 714 may be repeated for each subsequent song for which a partial fingerprint is received 710.

FIG. 8 is a flow diagram illustrating another representative embodiment of a method for providing song fingerprints and enabling devices to detect the end of an audio segment. While FIG. 8 is described in terms of the content being an audio segment, those skilled in the art will appreciate from the description provided herein that the content may be other than an audio segment. In the illustrated embodiment, a partial fingerprint is calculated 800 at a device for a portion of an audio segment playing on the device. The device determines 802 when the audio segment has stopped playing on the device by locally performing repeated partial fingerprint calculations and comparisons of the resulting partial fingerprints to a reference fingerprint for that audio segment.

In one embodiment, the reference fingerprint may be derived 802A at the device itself. For example, the reference fingerprint(s) may include one or more prior fingerprints calculated at the device for that audio segment. In such a case, the local comparisons of the resulting partial fingerprints to the reference fingerprint(s) for that audio segment involves locally performing the comparisons of the resulting partial fingerprints to the one or more prior partial fingerprint calculations on the device for that audio segment. In other words, as the device continues to calculate fingerprints for some content such as a song, those calculated fingerprints may then serve as the reference fingerprints to which the newly calculated fingerprints are compared. In another embodiment, the reference fingerprint may be derived 802B at a remote device, such as a server or other network element. In such an embodiment, the network element may perform a search for the audio segment based on the calculated partial fingerprint(s), and if located, provide the device with an audio segment fingerprint as the reference fingerprint.

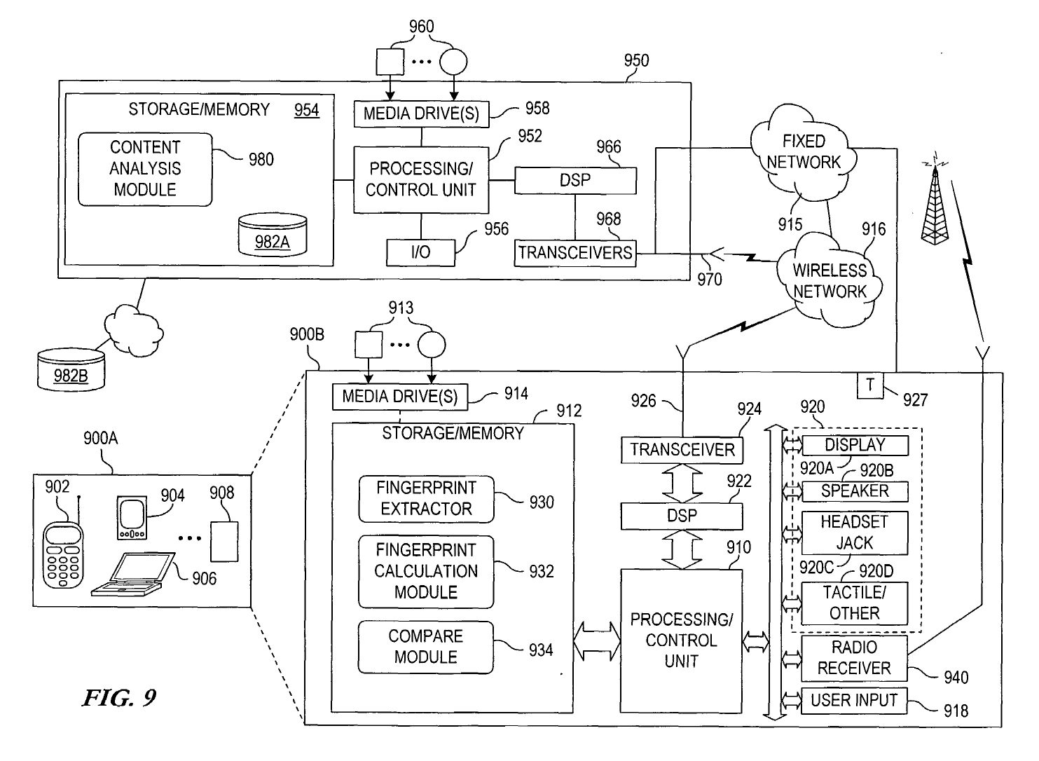

A representative system in which the present invention may be implemented or otherwise utilized is illustrated in FIG. 9. The device(s) 900A represents any device capable of performing the device functions previously described. In the illustrated embodiment, the device 900A represents a mobile device capable of communicating over-the-air (OTA) with wireless networks and/or capable of communicating via wired networks. By way of example and not of limitation, the device 900A includes mobile phones (including smart phones) 902, personal digital assistants 904, computing devices 906, and other networked terminals 908.

The representative terminal 900A utilizes computing/processing systems to control and manage the conventional device activity as well as the device functionality provided by the present invention. For example, the representative wireless terminal 900B includes a processing/control unit 910, such as a microprocessor, controller, reduced instruction set computer (RISC), or other central processing module. The processing unit 910 need not be a single device, and may include one or more processors. For example, the processing unit may include a master processor and one or more associated slave processors coupled to communicate with the master processor.

The processing unit 910 controls the basic functions of the device 900B as dictated by programs available in the program storage/memory 912. The storage/memory 912 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the terminal. The storage 912 may also include one or more of other types of read-only memory (ROM) and programmable and/or erasable ROM, random access memory (RAM), subscriber interface module (SIM), wireless interface module (WIM), smart card, or other fixed or removable memory device/media. The programs may also be provided via other media 913, such as disks, CD-ROM, DVD, or the like, which are read by the appropriate interfaces and/or media drive(s) 914. The relevant software for carrying out terminal operations in accordance with the present invention may also be transmitted to the device 900B via data signals, such as being downloaded electronically via one or more networks, such as the data network 915 or other data networks, and perhaps an intermediate wireless network(s) 916 in the case where the device 900A/900B is a wireless device such as a mobile phone.

For performing other standard terminal functions, the processor 910 is also coupled to user input interface 918 associated with the device 900B. The user input interface 918 may include, for example, a keypad, function buttons, joystick, scrolling mechanism (e.g., mouse, trackball), touch pad/screen, and/or other user entry mechanisms.

A user interface (UI) 920 may be provided, which allows the user of the device 900A/B to perceive information visually, audibly, through touch, etc. For example, one or more display devices 920A may be associated with the device 900B. The display 920A can display web pages, images, video, text, links, television, visual radio information and/or other information. A speaker(s) 920B may be provided to audibly present instructions, information, radio or other audio broadcasts, etc. A headset/headphone jack 920C and/or other mechanisms to facilitate audio presentations may also be provided. Other user interface (UI) mechanisms can also be provided, such as tactile 920D or other feedback.

The exemplary mobile device 900B of FIG. 9 also includes conventional circuitry for performing wireless transmissions over the wireless network(s) 916. The DSP 922 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 924 includes at least a transmitter and receiver, thereby transmitting outgoing wireless communication signals and receiving incoming wireless communication signals, generally by way of an antenna 926. Where the device 900B is a non-mobile or mobile device, it may include a transceiver (T) 927 to allow other types of wireless, or wired, communication with networks such as the Internet. For example, the device 900B may communicate via a proximity network (e.g., IEEE 802.11 or other wireless local area network), which is then coupled to a fixed network 915 such as the Internet. Peer-to-peer networking may also be employed. Further, a wired connection may include, for example, an Ethernet connection to a network such as the Internet. These and other manners of ultimately communicating between the device 900A/B and the server(s) 950 may be implemented.

In one embodiment, the storage/memory 912 stores the various client programs and data used in connection with the present invention. For example, a fingerprint extractor module 930 can be provided at the device 900B to sample an audio stream received by way of a broadcast receiver, such as the radio receiver/tuner 940. For example, a fingerprint extractor module 930 can be provided to sample an audio stream (e.g., radio signal) and may be, for example, a software/firmware program(s) executable via the processor(s) 910. The fingerprint extractor may calculate a sample of, for example, several seconds although the particular duration may vary. Longer durations may produce more accurate results. In one embodiment, at the end of a sampling period, a request is sent to the recognition backend, such as a server 950 that looks up the song or other content item in a database based on the fingerprint sample(s).

The device 900B includes a fingerprint calculation module 932 to generate the fingerprint portions previously described. A compare module 934 can perform the local comparisons previously described, such as comparing the locally generated fingerprints to the reference fingerprint to determine when the content segment has ended. These and other modules may be separate modules operable in connection with the processor 910, may be a single module performing each of these functions, or may include a plurality of such modules performing the various functions. In other words, while the modules are shown as multiple software/firmware modules, these modules may or may not reside in the same software/firmware program. It should also be recognized that one or more of these functions may be performed using hardware. For example, a compare function may be performed by comparing the contents of hardware registers or other memory locations using hardware compare functions. These modules are representative of the types of functional and data modules that may be associated with a terminal in accordance with the invention, and are not intended to represent an exhaustive list. Also, other functions not specifically shown may be implemented by the processor 910.

FIG. 9 also depicts a representative computing system 950 operable on the network. One or more of such systems 950 may be available via a network(s) such as the wireless 916 and/or fixed network 915. In one embodiment, the computing system 950 represents a content recognition server, or visual radio server, such as that shown as the recognition server 410 of FIG. 4. The system 950 may be a single system or a distributed system. The illustrated computing system 950 includes a processing arrangement 952, which may be coupled to the storage/memory 954. The processor 952 carries out a variety of standard computing functions as is known in the art, as dictated by software and/or firmware instructions. The storage/memory 954 may represent firmware, media storage, and/or memory. The processor 952 may communicate with other internal and external components through input/output (I/O) circuitry 956. The computing system 950 may also include media drives 958, such as hard and floppy disk drives, CD-ROM drives, DVD drives, and other media 960 capable of reading and/or storing information. In one embodiment, software for carrying out the operations at the computing system 950 in accordance with the present invention may be stored and distributed on CD-ROM, diskette, magnetic media, removable memory, or other form of media capable of portably storing information, as represented by media devices 960. Such software may also be transmitted to the system 950 via data signals, such as being downloaded electronically via a network such as the data network 915, Local Area Network (LAN) (not shown), wireless network 916, and/or any combination thereof.

In accordance with one embodiment of the invention, the storage/memory 954 and/or media devices 960 store the various programs and data used in connection with the present invention. For example, the storage 954 may include a content analysis module 980 that is configured to locate a content fingerprint that represents some content item, where that content item is identifiable via the fingerprint received from the device 900B. For example, the content analysis module can compare the received partial fingerprint to all of the more complete fingerprints in the content database 982A (e.g., song database). In one embodiment, the content analysis module therefore includes a comparison module configured to compare these fingerprints. When a match is found, the song or other content item corresponding to that fingerprint is known, and the more complete fingerprint and/or associated metadata can then be returned to the device 900B. In the context of a visual radio server, the storage/memory 954 may include the content database 982A (e.g., song database) where the desired content is stored and located using the fingerprint(s) received from the device 900B. Alternatively, such a database 982B may be in a separate server, such as a music recognition server accessible via a network or otherwise.

The illustrated computing system 950 also includes DSP circuitry 966, and at least one transceiver 968 (which is intended to also refer to discrete transmitter/receiver components). While the server 950 may communicate with the data network 915 via wired connections, the server may also/instead be equipped with transceivers 968 to communicate with wireless networks 916 whereby an antenna 970 may be used.

Hardware, firmware, software or a combination thereof may be used to perform the functions and operations in accordance with the invention. Using the foregoing specification, some embodiments of the invention may be implemented as a machine, process, or article of manufacture by using standard programming and/or engineering techniques to produce programming software, firmware, hardware or any combination thereof. Any resulting program(s), having computer-readable program code, may be embodied within one or more computer-usable media such as memory devices or transmitting devices, thereby making a computer program product, computer-readable medium, or other article of manufacture according to the invention. As such, the terms “computer-readable medium,” “computer program product,” or other analogous language are intended to encompass a computer program existing permanently, temporarily, or transitorily on any computer-usable medium such as on any memory device or in any transmitting device.

From the description provided herein, those skilled in the art are readily able to combine software created as described with appropriate general purpose or special purpose computer hardware to create a computing system and/or computing subcomponents embodying the invention, and to create a computing system(s) and/or computing subcomponents for carrying out the method(s) of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
presenting content via a device;
transmitting at least one calculated fingerprint representative of at least a portion of the content;
receiving a content fingerprint for the content in response to transmitting the at least one calculated fingerprint; and
locally comparing further calculated fingerprints to the content fingerprint to identify an end to the presentation of the content.

2. The method of claim 1, further comprising receiving metadata associated with the content in response to transmitting the at least one calculated fingerprint.

3. The method of claim 2, further comprising presenting at least a portion of the metadata contemporaneously with the presentation of the content via the device.

4. The method of claim 3, further comprising discontinuing presentation of the metadata upon detection of the end to the presentation of the content.

5. The method of claim 2, wherein the content comprises at least an audio stream of audio items, and further comprising presenting at least a portion of the metadata via a display of the device during the audio presentation of a corresponding one of the audio items.

6. The method of claim 5, wherein at least one of the audio items comprises a song, and wherein presenting at least a portion of the metadata comprises visually presenting at least one of text or graphic information related to the song currently played via the audio stream.

7. The method of claim 1, further comprising:
locally calculating at the device the at least one calculated fingerprint representative of at least a portion of the content; and
locally calculating at the device the further calculated fingerprints that are compared to the content fingerprint.

8. The method of claim 1, wherein the content comprises a plurality of content items, and wherein receiving a content fingerprint comprises receiving a fingerprint representative of at least a remaining part of the content item from which the calculated fingerprint was based.

9. The method of claim 1, wherein the content comprises a plurality of content items, and wherein receiving a content fingerprint comprises receiving a fingerprint representing a plurality of portions of the content item from which the calculated fingerprint was based.

10. The method of claim 1, wherein the content comprises a plurality of content items, and wherein receiving a content fingerprint comprises receiving a fingerprint representative of any temporal portion of the content item from which the calculated fingerprint was based.

11. The method of claim 1, wherein receiving a content fingerprint comprises receiving a more comprehensive fingerprint relative to the calculated fingerprint in response to transmitting the at least one fingerprint.

12. The method of claim 1, wherein the content comprises streaming content, and further comprising the device calculating the at least one calculated fingerprint by generating the fingerprint for a temporal portion of the streaming content.

13. The method of claim 1, wherein locally comparing further calculated fingerprints to the content fingerprint to identify an end to the presentation of the content comprises locally comparing the calculated fingerprints to the content fingerprint until the calculated fingerprint no longer corresponds to the content fingerprint.

14. The method of claim 1, further comprising repeatedly calculating the fingerprints at the device and locally comparing the calculated fingerprints to the content fingerprint until the calculated fingerprint no longer corresponds to the content fingerprint.

15. The method of claim 1, further comprising substantially continuously calculating the fingerprints at the device and locally comparing the calculated fingerprints to the content fingerprint until the calculated fingerprint no longer corresponds to the content fingerprint.

16. A method comprising:
receiving a partial fingerprint representative of a portion of a content item;
locating a content fingerprint based on the content item identified by the partial fingerprint; and
transmitting the content fingerprint associated with the content item corresponding to the partial fingerprint for use by devices in locally detecting an end of a local presentation of the content item.

17. The method of claim 16, further comprising:
locating metadata based on the content item identified by the partial fingerprint; and
transmitting the metadata associated with the content item for use by devices in presenting at least some of the metadata in connection with presentation of the content item.

18. The method of claim 17, wherein the metadata comprises information characteristics related to the located content item, and comprises any one or more of textual, audio, graphical or multimedia information.

19. The method of claim 16, wherein locating a content fingerprint comprises searching at least one database to determine whether the database includes information for a song represented by the partial fingerprint.

20. The method of claim 16, further comprising searching a database to locate the content item represented by the partial fingerprint, and wherein locating a content fingerprint comprises identifying the content fingerprint associated with the content item located in the database.

21. The method of claim 20, further comprising locating metadata from the database based on the content item identified by the partial fingerprint, and transmitting the metadata associated with the content item for use by devices in presenting at least some of the metadata in connection with presentation of the content item.

22. The method of claim 16, wherein the content fingerprint comprises a more comprehensive fingerprint for the content item relative to the partial fingerprint.

23. The method of claim 16, in response to a device locally identifying an end of a local presentation of the content item, repeating the receiving, locating and transmitting for each subsequent content item.

24. A method comprising:
calculating a partial fingerprint at a device for a portion of an audio segment playing on the device; and
at the device, determining when the audio segment has stopped playing on the device by locally performing repeated partial fingerprint calculations and comparisons of the resulting partial fingerprints to one or more reference fingerprints for that audio segment.

25. The method of claim 24, wherein the one or more reference fingerprints comprises one or more prior partial fingerprints calculated at the device for that audio segment, and wherein locally performing comparisons of the resulting partial fingerprints to a reference fingerprint for that audio segment comprises locally performing comparisons of the resulting partial fingerprints to the one or more prior partial fingerprint calculations on the device for that audio segment.

26. The method of claim 24, further comprising performing a search at a network element for the audio segment based on the calculated partial fingerprint, and providing an audio segment fingerprint as the reference fingerprint to the device in response to locating the audio segment.

27. The method of claim 26, wherein performing repeated partial fingerprint calculations and comparisons comprises performing repeated partial fingerprint calculations and comparisons of the resulting partial fingerprints to the audio segment fingerprint received from the network element.

28. An apparatus comprising:
a user interface configured to present content;
a transmitter configured to transmit at least one calculated fingerprint representative of at least a portion of the presented content;
a receiver configured to receive a content fingerprint for the presented content in response to transmitting the at least one calculated fingerprint; and
a compare module configured to compare further calculated fingerprints to the content fingerprint to identify an end of the content presentation.

29. The apparatus as in claim 28, further comprising a fingerprint calculation module configured to calculate the at least one calculated fingerprint based on at least a portion of the presented content, and configured to calculate the further calculated fingerprints used for comparison to the content fingerprint.

30. The apparatus as in claim 28, wherein the user interface is further configured to present metadata associated with the content and received in response to transmitting the at least one calculated fingerprint.

31. The apparatus as in claim 30, wherein the user interface is further configured to discontinue presentation of the metadata upon detection of the end of the content presentation.

32. The apparatus as in claim 30, wherein the user interface comprises at least a display.

33. The apparatus as in claim 28, wherein the user interface comprises any one or both of a visual or audio component.

34. The apparatus as in claim 28, wherein the user interface comprises at least a speaker.

35. The apparatus as in claim 28, wherein the user interface comprises at least a display.

36. The apparatus as in claim 28, further comprising memory configured to locally store the content fingerprint for the presented content, and wherein the compare module is further configured to compare further calculated fingerprints of a subsequent presentation of the content to the locally stored content fingerprint to identify the end of the subsequent presentation of the content.

37. An apparatus comprising:
a receiver configured to receive a calculated fingerprint representative of a portion of a content item;
a content analysis module configured to locate a content fingerprint based on the content item identified by the calculated fingerprint; and
a transmitter configured to send the content fingerprint associated with the located content item for use by devices in locally identifying an end of a local presentation of the content item.

38. The apparatus as in claim 37, wherein the content analysis module is further configured to locate metadata associated with the content item, based on the content item identified by the calculated fingerprint.

39. The apparatus as in claim 38, wherein the content analysis module comprises instructions and a processing system capable of executing the instructions to search a database for the content item and the metadata identified by the calculated fingerprint.
